(19) United States
(12) Patent Application Publication
(10) Pub. No.: US 2015/0052136 A1
(43) Pub. Date: Feb. 19, 2015

(54) Image Categorization Database and Related Applications

(71) Applicant: Qin Zhang, Los Angeles, CA (US)

(72) Inventor: Qin Zhang, Los Angeles, CA (US)

(21) Appl. No.: 13/969,609

(22) Filed: Aug. 19, 2013

(51) Int. Cl. G06F 17/30

(52) U.S. Cl. CPC G06F 17/30244
USPC 707/737; 707/803

(57) ABSTRACT

The present invention relates to a system and method for providing a new way of categorizing and searching image files. More specially, the present invention provides a system and method that can provide image categorization in a game like environment wherein the participants can freely input language units that describe or refer to corresponding images, wherein the inputted language units can be categorized and corresponding scores will be given according to the which categories the inputted language units fall into, wherein an image categorization database can be established and images can be searched according to the various types of categorization, and the categories of the language units in the image database can be used to rank image search results.

### FIELD OF INVENTION

The present invention relates to a system and method for providing a new way of categorizing and searching image files. More specially, the present invention provides a system and method that can provide image categorization in a game like environment wherein the participants can freely input language units that describe or refer to corresponding images, wherein the inputted language units can be categorized and corresponding scores will be given according to the which categories the inputted language units fall into, wherein an image categorization database can be established and images can be searched according to the various types of categorization, and the categories of the language units in the image database can be used to rank image search results.

### BACKGROUND OF THE INVENTION

Various words or phrases can be used to describe or refer to images. Currently, the language and image cross references is mostly limited to general object description, and other references are usually segmented

The more specific image and language association will be useful for human information consumption and entertainment. Visualization not only will help the information consumers appreciate and understand the information more, it will also enhance and sustain the interests regarding the information. Visualization will also provide relaxation and enjoyment of the visual effects. Therefore, multiple levels of association between images and languages are needed so that images can be most closely associated and referred to for all language components, and a system that can structurally arrange the levels of association and to rank the images according to the degree of associations with languages so that to display images in ultimate fashion is preferable.

It would be difficult or impossible for machines to provide all the descriptions and references that are related to the images, therefore large number of participants would be very helpful in establishing image database with various language and image associations.

### SUMMARY OF THE INVENTION

The present invention provides means for providing ultimate image and language association and means to search and display images ranked by the types of association with language units (including words, phrases, or even sentences).

In one preferred embodiment of the present invention, the images can be displayed randomly one by one to participants and the inputs from the participants corresponding to the images can be categorized according to various categorizations, and the inputs are evaluated and given scores according to the types of categorizations they fall into.

The categorized language units associated with the images can be used to construe a database that can be searched by inputted language units. The image search results can be ranked according to how the images are associated with language units and how the imputed terms are matched with the language units associated with the image in the database.

In one preferred embodiment of the present invention, if no direct match can be found in the image search database, the inputted language units can be processed by the thinking system and using information from the knowledge structure to find language units that are related in meaning, similar in meaning, broader or narrower in meaning with the inputted language units. Then the language units from the knowledge structure can be used to search the image database structure to find matches.

In one preferred embodiment of the present invention, images can be matched and linked to language units in contents with texts. In one preferred embodiment of the present invention, the texts in the webpage can be scanned and language units that match with language units in image database structure can be identified. Then, for each language unit in the web content, a search in the image database structure can be conducted, and image search results can be arranged and displayed in a webpage and linked to the corresponding language unit. The webpage with images can also include links to web pages that provide related information and/or advertisement. The benefit of this feature is to enhance user experience and best provide related information or promotions.

In another preferred embodiment of the present invention, image searches can be conducted using other language units in the web content along with the particular language unit. For example, language units in the web content that can clarify or define the meaning of the language units for the searches can be used along with the main language units for searches, and if the image database structure can provide matches to the main language units and the language units that could define or clarify the meanings of the main language units, then these matches could be ranked higher.

In an alternative preferred embodiment of the present invention, the language units that are related to images can be divided into different categories and assigned with different values for each language unit related to particular images. When conducting searches in image search database, the search results can be ranked according to the matching language units' categorization and values as well.

In an alternative preferred embodiment of the present invention, a database for language to language association can be established and users can respond to displayed language units by inputting other language units related in meaning to them. The inputs from the users can be categorized according to divisions in element files.

The method of the present invention using thinking system comprising the step of

establishing a knowledge structure including a file organizing mechanism, and more than one element files, wherein the element files including identifying information and knowledge information;
establishing a processing structure comprising a process file organizing mechanism, and at least one process file;
establishing an image database structure comprising an image identification zone, an image file address zone, an image feature zone for image characteristics values, more than one categorized zones for language units related in meaning with the images, and an image database organizing mechanism;
establishing an executing system comprising an internal control mechanism and an inputting mode, a reading mode, a thinking mode, a writing mode, a memorizing mode, an outputting mode, an inquiry mode, verification mode, and a system update mode;
wherein the internal control mechanism further comprises internal control rules and structure rules, wherein the internal control rules include basic rules, task rules, and target rules;
establishing a system log;
running the executing system wherein the internal control mechanism can operate constantly, wherein the thinking mode, inquiry mode, memorizing mode, verification mode, and a system update mode can be activated according to the internal control rules of the internal control mechanism not triggered by an input;
if input information is to be received from an inputting device, the internal control mechanism will operate inputting mode according to the internal control rules, wherein the input information will be converted to format conformed with the format requirement by the executing system according to the inputting rules;
once input information is received by the executing system, the internal control mechanism will activate reading mode according to the internal control rules, wherein according to the reading rules, the input can be disseminated into elements and element files of the knowledge structure with corresponding elements matched with the input elements can be located and loaded into the executing system (or areas easily accessible by executing system) according to the file organizing mechanism of the knowledge structure;
the internal control mechanism can then activate the thinking mode, wherein according to the thinking rules designated by the internal control mechanism, the thinking mode can obtain the identifying information and knowledge information of the existing element files of the knowledge structure that match with the elements of the input information and trigger analyzing process of the thinking mode;
wherein the internal control mechanism can operate inquiry mode according to the internal control rules based on the results from the analyzing process of the thinking mode, wherein the inquiries can be sent to image database structure, to search image database structure, wherein the results of image search will be processed by writing mode and output mode, to provide output information;
if new links and/or new process files are established, the internal control mechanism can operate the verification mode to verify new direct links and the new linking processes, then operate the memorizing mode to save the results in the knowledge structure; the internal control mechanism can also operate the system update mode to update the internal control rules, and the process files in the process structure, wherein the system operator's participations are often needed;
wherein the entire process of the executing system can be saved in the system log.

According to the present invention, the human knowledge system basically is a system with multiple, multidimensional links between various language elements, and the function of the human languages, and more specifically sentences of the human languages is to establish and express links between various language elements. By treating sentences as links between elements, the variation and complexity of the sentence structures is dissolved.

The knowledge structure comprises numerous element files and a file organizing mechanism. Each element file contains information identifying and distinguishing the element and knowledge indicating direct connections of this element with other elements. The identifying information is about whether the element is a word, a phrase, a symbol, or a graphic, etc., and for a word, what language is the word, and whether the word is a noun, a verb, a pronoun, etc. The link information is about whether the meaning of the word is general, specific, or interchangeable with other words, the way the element is supposed to be used in sentences, the conditions and results related with the element, the attributes of the element, and other information indicating how this element is related to other elements. Further, information in the element files will tell executing system how to act in respond to the information. Preferably, each element file comprises an identification file, and a link file. The file organizing mechanism provides ways for the element files to be easily located by the executing system. The file name of the element file could be the name of the element. The element files could be arranged according to the alphabetical order of the elements, and the element files could be located alphabetically by the executing system according to the organizing mechanism.

establishing an image database structure comprising an image identification zone, an image file address zone, an image feature zone for image characteristics values, more than one categorized zones for language units related in meaning with the images, and an image database organizing mechanism;

Image database structure can comprise an image identification zone, an image file address zone, an image feature zone for image characteristics values, more than one categorized zones for language units related in meaning with the images, and an image database organizing mechanism, wherein each image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones.

The executing system can take information, read information, think about the information, make inquiry about information, write results, output results, verify changes and new processes, memorize changes to the element files and new processes, and update system commands or setup. The executing system comprises internal control mechanism contains internal control rules that are instructions so that not only it will be in action in respond to the input, but also will be in action according to the internal setup or instructions of the executing system.

### BRIEF DESCRIPTION OF THE DRAWINGS

The above and further features and advantages of the present invention may be appreciated from the detailed description of preferred embodiments with reference to the accompanying drawings, in which:

FIG. 1 is a schematic illustration of one preferred embodiment of the method of the present invention;

FIG. 2a is a schematic illustration of one preferred embodiment of the implication of the system of the present invention;

FIG. 2b is a schematic illustration of one preferred embodiment of the computer hardware implication of the system of the present invention;

FIG. 3 is a schematic illustration of one preferred embodiment of the knowledge structure of the system of the present invention;

FIG. 4 is an exemplary illustration of a word tree in a first link information file of an element file in the knowledge structure of the system of the present invention;

FIG. 5 is a schematic illustration of one preferred embodiment of the executing system of the system of the present invention;

FIG. 6 is an exemplary illustration of an image database structure of the system of the present invention;

FIG. 7 is an exemplary illustration of a user input image database of the system of the present invention;

FIG. 8 is an exemplary illustration of a language association database of the system of the present invention;

FIG. 9 is an exemplary illustration of a user input language database of the system of the present invention.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

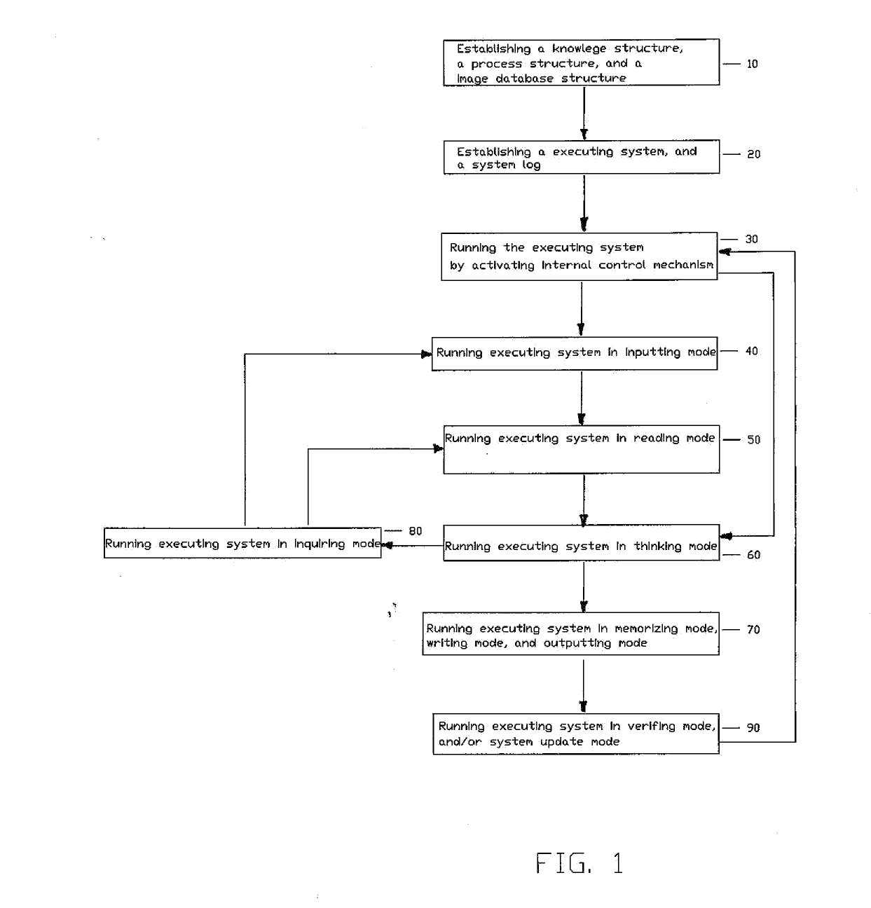

As seen in FIG. 1, the method of the present invention comprises the steps of:

Step 10a: establishing a knowledge structure including a file organizing mechanism, and more than one element files, wherein the element file includes identifying information and knowledge information;

wherein the identifying information classify the elements, wherein the knowledge information includes meanings of the elements, wherein the knowledge information can include at least one direct links of the element with other elements of the knowledge structure.

Step 10b: establishing a process structure comprising a process file organizing mechanism, and at least one process file.

The process files are identified by the types of processes, the inputs, the outputs, and the conditions of the processes. The process files basically are files for rules of the processes. The purpose of building the process structure that contains process files is to provide a mechanism that the process files can be generated, modified and expanded by the operation of the executing system of the present invention. The process file organizing mechanism can identify and locate the process files and provide access for the executing system to use the process files.

Step 10e: establishing an image database structure wherein the language units (including words, phrases, or sentences) that can be related to images are categorized according to different categories.

In one preferred embodiment of the present invention, the image database structure can be further developed by user participations, wherein the images are display one by one to participants and the inputs from the participants can be saved and categorized according to various categorizations, and the inputs are evaluated and given scores by the types of categorizations they fall into.

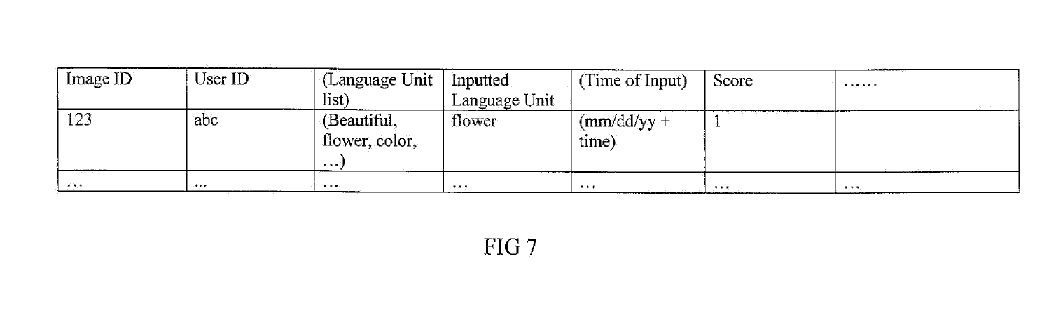

In a preferred embodiment of the present invention, as shown in FIG. 7 a user input image database can be established wherein for each image identification value, corresponding input for each participant for the current time can be recorded and retrieved. The input can be compared with language units in image database structure, and if there is a match, the user can be given a score for this input and this score (based on which categorized zone the language unit falls into) can be recorded in the user input image database. In a preferred embodiment of the present invention, for each image, corresponding inputs for each participant in the past can also be recorded and retrieved, and an current input can also be first compared with the user input image database, and if the user had provided the same input for the same image, the user can be given the score recorded in the user input image database, and the user input image database can record the frequency of this input. If no matches can be found in the image database structure and the user input image database, this input can be flagged for further evaluation by the human system operators. The system operators can determine which categorized zone the input falls into and give the score for this input according to which categorized zone this input falls into. The user can be given the total score for all the inputs corresponding to each image and adding scores for all the images. The user input image database can also record input for each time of the image displayed.

In another preferred embodiment of the present invention, if the user had provided the same input for the same image, the user can be given the score that could be lower than the score first given to this user for the first time input. If the inputted language units do not have matches in the image database structure, the system operator can award additional score to the participants if the inputs are related to the displayed images. The frequency of participants' inputted language units for images can be a factor in ranking image search results.

The categorized language units associated with the images can be used to construe the image database structure that can be searched by inputting language units. The image search results can be ranked according to how the images are associated with language units and how the inputted language units are matched with the language units associated with the image in the database.

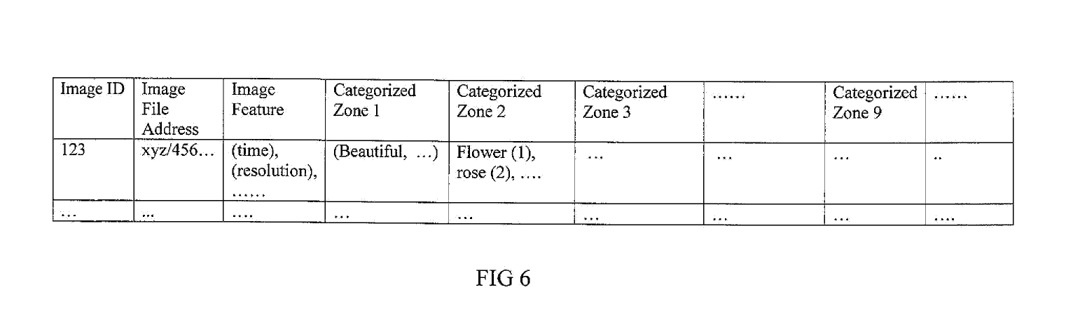

As shown in FIG. 6, an image database structure can comprise an image identification zone, an image file address zone, an image feature zone for image characteristics values, more than one categorized zones for language units related in meaning with the images, and an image database organizing mechanism, wherein each image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones.

The Image database structure can be used for organizing images in a close environment or in a broader environment (such as in the World Wide Web).

Step 20: establishing an executing system comprising an internal control mechanism and an inputting mode, a reading mode, a thinking mode, a writing mode, a memorizing mode, an outputting mode, an inquiry mode, verification mode, and a system update mode;

Establishing a system log;

wherein the inputting mode includes inputting rules, wherein the reading mode includes reading rules, wherein the thinking mode includes thinking rules, wherein the writing mode includes writing rules, wherein the memorizing mode includes memorizing rules, wherein the outputting mode includes outputting rules, wherein the inquiry mode includes inquiring rules, wherein the verification mode includes verification rules;
wherein the system update mode includes system update rules;
wherein the internal control mechanism includes internal control rules, and structure rules;
wherein the internal control rules further comprises basic rules, task rules, and target rules.

The internal control rules generally designate the operating process of the executing system. The entire operation of the thinking system is directed by various combinations of rules including internal control rules, and rules in various modes. The quality and ability of the thinking system depends on the sophistication and complicity of the rules.

The structure rules relate to the grammar and sentence structures of the language. For example, structure rules provide various sentence structures of various languages that can be used for different purposes.

The task rules include search rules for searching image database structure, wherein the search rules further include ranking rules, wherein the ranking rules rank image search results according to factors such as categorized language units related in meaning to the images, and characteristics of images.

Step 30: running the executing system wherein the internal control mechanism can operate constantly, wherein the thinking mode, inquiry mode, memorizing mode, verification mode, and the system update mode can be activated according to the internal control rules of the internal control mechanism not triggered by an input;

wherein according to the thinking rule, direct link between a first existing element and a second existing element can be used to establish new direct links between the first existing element and at least one existing element with direct link with the second existing element;
wherein according to the internal control rules, and the inquiry rules, inputting rules, reading rules, thinking rules, memorizing rules, verification rules, and the system update rules, the executing system can obtain and verify information from external source and update the knowledge structure and image database structure;
wherein according to the internal control rules, inquiry rules, inputting rules, reading rules, thinking rules, writing rules, output rules, and the system update rules, the executing system can search the image database structure with inputted language units;
wherein according to the thinking rules, new process files can be obtained by processing information from the existing element files, and existing process files.

Step 40: if input information is received from an inputting device, the internal control mechanism will operate inputting mode according to the internal control rules, wherein the input information will be converted to format conformed with the format requirement by the executing system according to the inputting rules, wherein information other than language may be converted to language information by information processing tools.

Step 50: once input information is received and processed in the inputting mode by the executing system, the internal control mechanism will activate reading mode according to the internal control rules, wherein according to the reading rules, the input information (especially the language input) can be disseminated into elements and element files of the knowledge structure of the corresponding elements matched with the input elements will be located and loaded into the executing system (or areas easily accessible by executing system) according to the file organizing mechanism of the knowledge structure.

Step 60: the internal control mechanism will activate the thinking mode to obtain the identifying information and knowledge information of the element files of each of the input elements according to the thinking rules,

wherein according to the thinking rules designated by the internal control mechanism, the thinking mode can analysis the input information according to the identifying information and the knowledge information of the element files;
wherein thinking mode can obtain the language units from the knowledge information of the element files related in meaning to input information, that can be used by the executing system to search image database structure along with the inputted language unit.

Step 70: wherein if the thinking mode established the new direct link, the new direct link can be saved to the element file of the first existing element and the element file of the second existing element by the memorizing mode according to the memorizing rule, wherein the linking process for linking the first existing element with the second existing element can be saved as a process file to a process structure by the memorizing mode according to the memorizing rule, wherein information including the new direct link between the first existing element and the second existing element can be written to a display device by the writing mode according to the writing rules and the structure rules of the internal control mechanism, wherein the new direct link between the first existing element and the second existing element can also lead to information other than language and be outputted as control signal to output device by the outputting mode according to the outputting rules.

Step 80: wherein the internal control mechanism can operate inquiry mode according to inquiring rules, wherein the inquiries can be sent to display device or output device to inquire information, wherein the input information responding to the inquiries can be processed by inputting mode, reading mode, and thinking mode;

wherein if the internal control mechanism operates inquiry mode according to inquiring rules, inquiries can be made to the image database structure, wherein the inputted language unit and/or language units from the element files can be used to find images that have the language association with the inputted language unit and/or language units from the element files when the inputted language unit and/or language units can find direct matches with the language units in categorized zones, and the search results can be ranked according to ranking rules;

Step 90: if new links and/or new element files and/or new process files are established, the internal control mechanism can operate the verification mode to verify new direct links and the new linking processes; the internal control mechanism can also operate the system update mode to update the internal control rules, the structure rules, and the process files in the process structure, wherein the system operator's participations are often needed;

wherein if image search results are obtained by operating inquire mode to search image database structure and the search results can be ranked by ranking rules, the writing mode can write the search results according to writing rules and send to output devices according to output rules;
wherein the internal control mechanism can save the operating process of the executing system to system log files in the system log according to the internal control rules.

In one preferred embodiment of the present invention, the system log can be searched to obtain process related information. For example, if the system of the present invention is used to perform search function, the search processes in the system log along with some user information such as user profile can be used for conducting surveys or market researches, etc.

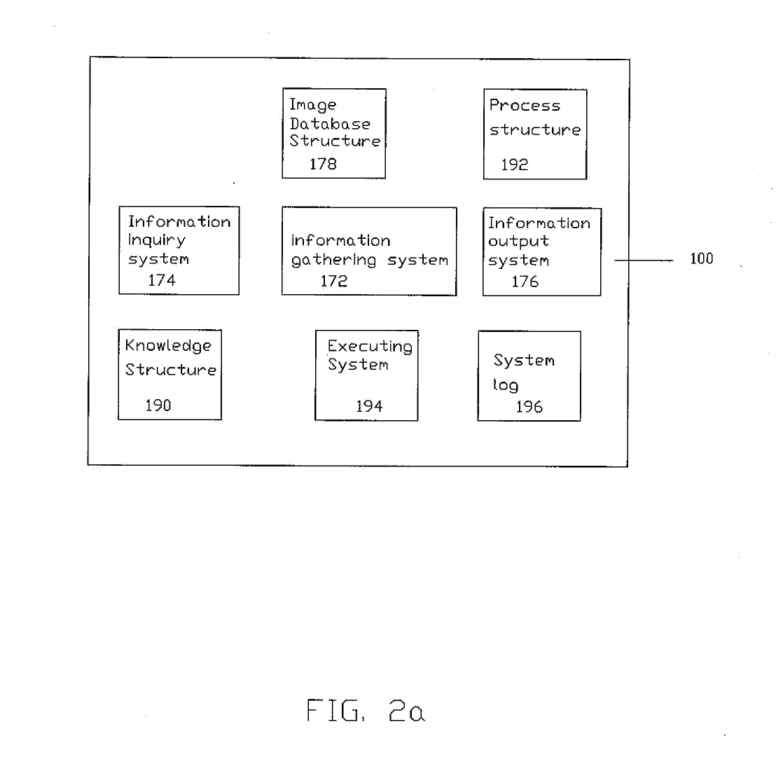

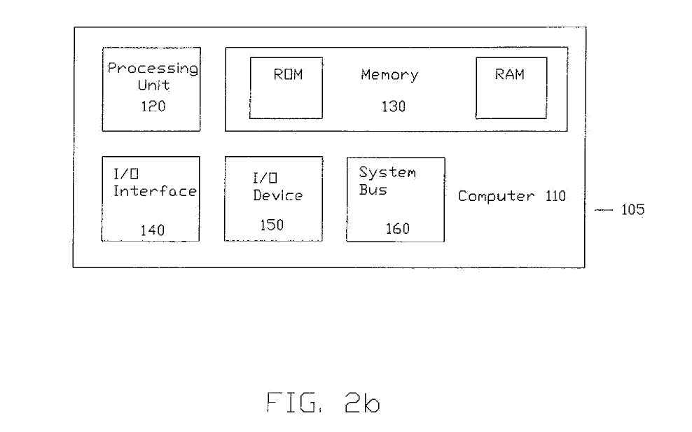

In one preferred embodiment of the present invention, as shown in FIG. 2a, the thinking system 100 comprises: an information gathering system 172, an information inquiry system 174, an information output system 176, a knowledge structure 190, a process structure 192, an image database structure 178, an executing system 194, and a system log 196.

In one preferred embodiment of the present invention, as shown in FIG. 2b, a computer hardware system 105 is used as part of the embodiment of the present invention that includes at least one computer 110, having at least a processing unit 120, a memory 130, an I/O interface 140, an I/O device 150, and a system bus 160 that interconnects various system components to the processing unit. The memory includes at least one read only memory (ROM) and one random access memory (RAM). A basic I/O interface, containing the basic routines that help to transfer information between elements within the computer, such as during start-up, is stored in ROM. The system bus comprises bus structures such as address buses, data buses, and control buses.

In this embodiment, the information gathering system 172 includes I/O devices 150 that provide input to the computer 110, and the information inquiry system 174, the information output system 176 are I/O devices 150 that the computer 110 provides control. The knowledge structure 190, the process structure 192, the image database structure 178, the executing system 194, and the system log 196 are mostly software systems that are contained in the memory 130. The operation of the executing system 194 is mostly realized through the operation of at least one processing unit 120.

The information gathering system 172 may further comprises a word input system, and a touch/scan input system. The image database structure 178 could be located in a remote location in a computer network, or can be dispersed in various locations connected by one or more networks.

In a preferred embodiment, the knowledge structure 190, the process structure 192, the image database structure 178, the executing system 194, and the system log 196, can be duplicated.

### Knowledge Structure

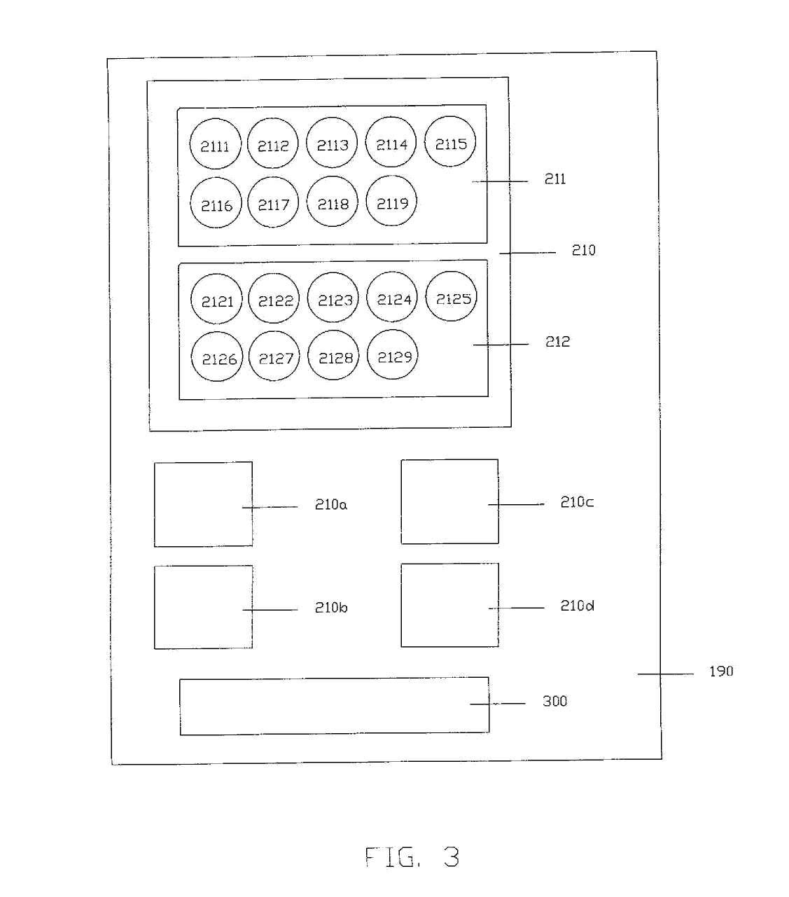

In one preferred embodiment of the present invention, as shown in FIG. 3, the knowledge structure 190 of the present invention comprises knowledge files and file organizing mechanism 300.

The knowledge files comprises numerous element files 210. Each element file 210 comprises an identification file 211, and a link file 212.

In a preferred embodiment, the identification file 211 comprises a first identification value 2111, a second identification value 2112, a third identification value 2113, a fourth identification value 2114, a fifth identification value 2115, a sixth identification value 2116, a seventh identification value 2117, a eighth identification value 2118, and a ninth identification value 2119. Different identification values of an element file can trigger different actions of the executing system 194.

In one preferred embodiment, the first identification value 2111 indicates the first element file 210 is a file for a word. The second identification value 2112 indicates what type of language is the word. In general the first identification value 2111 of a element file 210 could indicates whether the element is a word, a phrase, a sentence, a paragraph, a collection of paragraphs, even a book, a process, a symbol, a graphic, a formula, a sound or some other type of record.

The third identification value 2113 indicates whether the word is a noun, a verb, a pronoun, a verbal, an adjective, an adverb, an article, a preposition, a conjunction, or an interjection. In general, the second identification value 2112 through the ninth identification value 1119 could be any feature indication or a blank value.

The fourth identification value 2114 indicates the classes of nouns, verbs, pronouns, adjectives, and adverbs. The nouns are divided into classes including common nouns, proper nouns, collective nouns, count nouns, mass nouns, concrete nouns, abstract nouns. The verbs are divided into classes including transitive, intransitive, linking verbs, and auxiliary verbs. Pronouns fall into several classes including personal pronouns, indefinite pronouns, demonstrative pronouns, the relative pronouns, intensive and reflexive pronouns, intensive pronouns, reflexive pronouns, interrogative pronouns. Adjectives are divided into descriptive adjectives, limiting adjectives, possessives, words that show number, demonstrative adjectives, interrogative adjectives, and numbers, proper adjectives, attributive adjectives, predicate adjectives. Adverbs can be divided into classes of modifiers of verbs, adjectives and other adverbs; sentence modifiers. Words of different classes represent different meanings, usage, and corresponding sentence structures.

The fifth identification value 2115 indicates the forms of nouns, verbs, pronouns, adjectives, and adverbs. Nouns have forms in subjective and objective case, possessive case, and plural. Verbs have forms of simple, past tense, past participle, present participle, and -s form. Pronouns have forms of subjective, objective, possessive. Adjectives have three forms: positive, comparative, and superlative. Adverbs have three forms: positive, comparative, and superlative. Words in different forms reflect their functions, usage, and corresponding sentence structures.

In one preferred embodiment, the sixth identification value 2116 indicates the category of a noun (or noun phrase), whether it is for who, what, where, when or how. For example, for the phrase “Los Angeles”, it can belong to either what or where category.

The link file 212 indicates the connections the element has with other elements. The link file 212 comprises a first link information file 2121, a second link information file 2122, a third link information file 2123, a fourth link information file 2124, a fifth link information file 2125, a sixth link information file 2126, a seventh link information file 2127, an eighth link information file 2128, and a ninth link information file 2129.

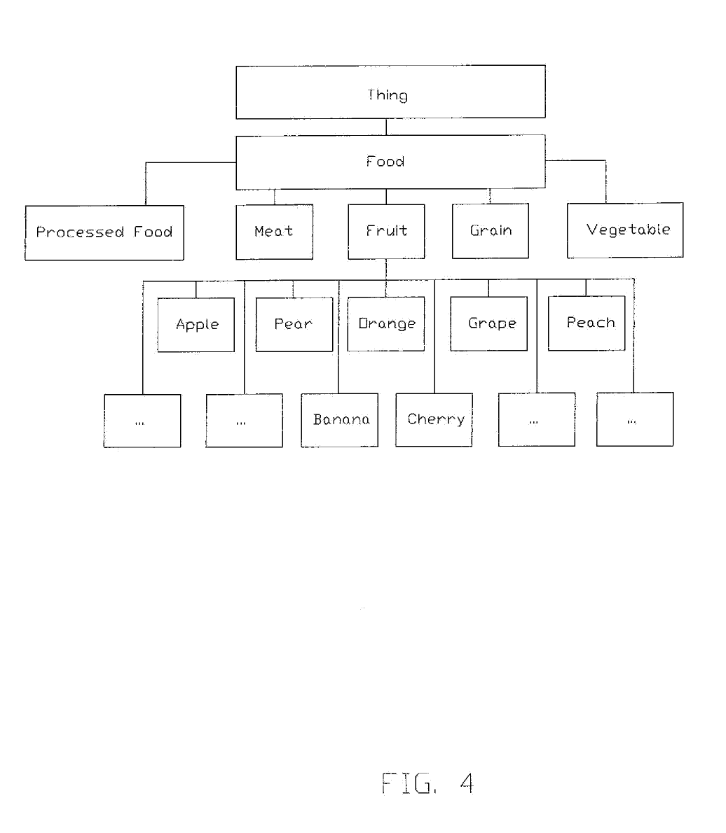

In a preferred embodiment, the first link information file 2121 establishes vertical connections between words. The first link information file 2121 comprises a word tree field, and an information field. The word tree field contains one or more groups of words connected by a tree like structure, wherein the word in the top of the tree structure is most general in meaning Going down the tree structure, the words will be more specific in meaning. Preferably, the word tree structure should contain all words that have vertical connection with this element. For example, for the element file for fruit, the word tree field may contain thing, food, fruit, apple, pear, orange, etc. as indicated in FIG. 4. In general, a word in lower level should be able to replace the word in the upper level in just about all sentences. If in some situations there are exceptions (usually when words in the word tree fields have multiple meanings, and only one meaning related to the word of the element file), these exceptions should be provided in the information field. If the word of the element file has more than one meaning, more than one word tree can be provided in the word tree field, and the condition or usage of the different word trees will be indicated in the information field. Phrases can be treated like words as for elements of the element files, or in the element files, with indication that they are phrases functioning as words.

The first link information file 2121 would likely be blank for pronouns, propositions, conjunctions, interjections, and articles.

The second link information file 2122 establishes horizontal connections between words. The second link information file 2122 comprises word field, and word information field. The word field contains words that are interchangeable with the word of the element file 210. If in some situations there are exceptions (for example, when the word has different meanings), these exceptions should be provided in the word information field. The words that have similar meaning with the word of the element file 212 can also be included in the word field, wherein the word information field will contain the differences in meanings and functions of the words. The word field may also contain the words in different forms with the same meaning as the word of the element file 210, wherein the word information field will indicate difference in usages and functions. The word field may also contain words in other languages that have similar meanings as the word of the element file 210, wherein the word information field will indicate the usage and corresponding sentence structures information, etc. Phrases can be treated like words as for elements of the element files, or in the element files, with indication that they are phrases functioning as words. The second link information files are especially useful for nouns, verbs, pronouns in related to different forms, or tenses, or moods, or voices and their usages.

Pronouns are used as the replacement of nouns. The second link information file 2122 for a pronoun will indicate the noun or nouns that the pronoun is equivalent in meaning and usage to (often of nouns that are most general in meaning of the group). Difference forms can also be indicated with the information in different usages and functions.

The second link information file 2122 would likely be blank for propositions, conjunctions, interjections, and articles.

The third link information file 2123 establishes the way the word will be used in a sentence. The information in the third link information file 2123 usually contains information for the specific ways the word is used in sentences. The third link information file 2123 comprises a link field, and a link information field. For nouns, pronouns, the link field may contain their effects on verbs to change forms, the specific words they can be associated with, and specific changes in the sentence structure. For a noun, this file may indicate the link between the phrases that contain this noun with other words. For a verb, the link field may contain sentences that reflect the sentence structures of which the verb can be used. By using the words (nouns, pronouns, other verbs, etc.) that are most general in meaning to construct the sentences, the links between this verb and other words can be established. The link information filed indicates the condition for the verb can be used in these sentences. For example, for the word “eat”, the link field may contain: “Animals eat food. I eat food. I am eating food now. I ate food in the past. I have eaten food before. Animal eats food.”

The third link information file 2123 can also establish links for words in different groups but have related meaning. For example, verb “act” is related to noun “action”. This link can be indicated in the third link information file 2123 for both words.

For propositions, conjunctions, interjections, and articles, the third link information file 2123 may indicate the functions of the word of the element file in the sentences. A proposition always connects a noun, a pronoun, or a word group functioning as a noun to another word in the sentence. The noun, pronoun, or word group so connected is the object of the preposition. The preposition plus its object and any modifiers is a prepositional phrase. The third link information file 2123 of a proposition may contain commonly used prepositional phrase wherein other words in the phrases are in most possible general terms in meanings.

The fourth link information file 2124 establishes the conditions or occurrences that will cause the action or condition represented by the word. This file can be blank for the word of the element file that is a noun, pronoun. For verbs, this file can provide information as to why the action takes place. The link between the cause and the word of the element file can be absolute, i.e., if the conditions or occurrences are true, then the action that is represented by the word of the element file will occur. This is often represented by “if and then” phrase, and other words in the sentence should be the most general type of the words. For example, for word “rotate”, one sentence in the fourth link information file 2124 could be: “if a net eccentric force is applied to an object, then it will rotate.” You can see this type of links usually exist for natural occurrences. Sometimes, the link may or may not be true, depend on certain conditions. For example, for the word “boil”, one sentence establishes the link could be: “if the water temperature is 100° C., then it will be boiling in the normal atmosphere.” In this case, the temperature and pressure are both conditions for the water to boil. For some words, especially the words reflect the mental states or the actions of humans, or other living things, the links are not as certain. Then the sentences that reflect these links should reflect these uncertainties. For example, for the word “laugh”, one of the sentences establishes the link could be: “if one finds something interesting, then it is possible that this person will laugh”. The possible link could also be expressed using “because”: “Because I found something interesting, I laughed.” There could be more than one conditions or occurrences that will cause the action represented by the word. Therefore, the fourth link information file 2124 could contain numerous if-then sentences. The links can also be established by using existing process files.

For adjectives, the fourth link information file 2124 may provide information why the condition exists. The link between the cause and the condition can also be absolute, conditional, or a possibility. For example, for the word “wet”, one sentence establishes the link could be: “if it rains, then the ground will be wet”. For the word “rotatable”, one sentence establishes the link could be: “if the object is not fixed, then it is rotatable”. For the word “red”, one sentence established the link could be: “if the a person is embarrassed, the person's face could turn red.” The fourth link information file 2124 may also provide information why the condition exists for adverbs.

The fifth link information file 2125 establishes what will be the result of the action represented by the word. This file is for verbs mostly. The link between the word and the result can be absolute, conditional, or a possibility. The sentences could also be in the format of “if-then”. For example, for the word “burn”, one sentence establishes the link could be: “if a piece of material is burning, then it will consume oxygen.” For the word “hit”, one sentences establishes the link could be: “if an moving object is hit, then it will change directions.” For the word “run”, one sentences established the link could be: “if a person is running, then this person may be sweating.” As for the fourth link information file, there should be numerous links in the fifth link information file for the most time. It is the goal of the link files, as well as of the fourth link information files and the fifth link information files, to establish all possible links between words or phrases through direct links and indirect links. The links can also be established by using existing process files.

The sixth link information file 2126 contains identifying attributes and informational attributes of the word. The attributes are words that describe the characteristics of the word of the element file. Generally speaking, the sixth link information file 2126 is for nouns, and maybe verbs. The contents are words that define the fields and defined fields with or without values. For word that is general in meaning, most of the defined fields will not have values. For word that is the most specific, all the fields may have values. For example, a word “person” will have information attributes such as birthday, height, weight, blood type, education, number of brain, arms, etc., but most of field will be blank, except for one brain, two arms, etc. For a word “Elvis”, his birthday, blood type, education, etc, will all have a value. But here you can see the word “Elvis” is not the most specific, only if when you say “Elvis at 10:01 Jun. 1, 1951”, will you have the actually weight information. Words less general in meaning share the attributes for words that are more general in meaning linked by the word tree, but words general in meaning usually do not share all the attributes of the words less general in meaning linked by the word tree. Alternatively, the attribute information can be expressed in plain language. The identifying attributes usually are attributes with values that are unique to the element. The informational attributes can be in any thing related to the element. The format for the attributes can be as sentences or tables or forms, formulas, etc.

It can be noticed that if an attribute (especially an identifying attribute) of a word that does not have a value is assigned with a value, it will be equivalent to a word that is less general in meaning and linked by the word tree. For example, “person” is more general than “teacher” and linked with “teacher” by the word tree. So, a person who teaches will be a teacher.

People or places may have the same names but have different attributes. For example, John Smith is a frequently used name for many males, but they will have different birthdays, different heights and weights, and different occupations, and different personal characteristics. Paris in France is totally different from Paris in Texas of United States. The differences in the attributes may be reflected in separate and distinguish files in the sixth link information files, but it may be better that different element files are established for each person or place. These element files can be arranged in sub-element files under the same general names, and distinguished by distinct attributes, and specific identification number or value can be assigned to each element file.

Adjectives and adverbs usually indicate where, when, how, or to what extent, these features can be defined attributes of the nouns or verbs. Many adjectives can provide values or information of the attributes of the nouns. For example, green can be the color of an object, such as Granny Smith apple. Therefore, green can be value of the color attribute of the Granny Smith apple.

The seventh link information file 2127 establishes connections between word that indicates attributes of other words with those other words. This link information file indicates links that is the reverse side of the sixth link information file 2126. If a word is usually used as attribute or description of other words, then this file identify the word that this word defined or being attributed for. To reduce the size of the file, if the word is an attribute for a group of words linked by word tree, the seventh link information file 2127 may include only the word most general in meaning. For example, the word color can describe a physical existence, i.e., a thing. Therefore, seventh link information file 2127 may indicate that color is an attribute of a thing. It does not need to including other words that are less general in meaning and linked with “thing” by word tree, such as, tree, apple, chair, human, etc.

The comparative form or superlative form of adjectives and adverbs establish links for objects with similar values of the attributes.

The eighth link information file 2128 indicates the derivative attributes or derivative values of the word of the element file. For example, for word “place”, geographic location will be attribute for the place, and derivative attributes will be distance of this place with other places.

The ninth link information file 2129 indicates the connections between word that indicates the derivative attributes of other words with those other words. This link information file indicates links that are the reverse sides of the information indicated by the eighth link information file 2128. If a word can be used as derivative attribute of other words, then this file identify those other words. To reduce the size of the file, if the word is a derivative attribute for a group of words linked by a word tree, the ninth link information file 2129 may include only the word most general in meaning in the word tree.

The fourth link information file 2124, the fifth link information file 2125, the sixth link information file 2126, the seventh link information file 2127, the eighth link information file 2128, and the ninth link information file 2129 would likely be blank for propositions, conjunctions, interjections, and articles.

Other link information could be indicated in these link information files or other link information files.

If the element is a phrase, the first identification value 2111 indicates it is a file for a phrase. The second identification value 2112 indicates what type of language is the phrase. The third identification value 2113 indicates whether the phrase has the function of a noun, a verb, an adjective, an adverb, a preposition, a conjunction, or an interjection.

The link information file for a phrase will be similar to the file for the word that the phrase is equivalent in functions for. One specific difference is that the phrase can have most simplified form and more complex form. Generally, adding more words besides the key words will make the phrase more complex, and provides more specific meaning. The different form for the phrase can be provided in the first link information file and/or second link information file of the phrase.

Prepositional phrases usually function as adjectives or as adverbs, occasionally as nouns. The link information file for prepositional phrases may contain adjectives, adverbs, or nouns that they are similar to in meaning and function. The link information file may also contain information for special uses of the prepositional phrases in sentence.

Participles, gerunds, and infinitives—like other forms of verbs—may take subjects, objects, or complements, and they may be modified by adverbs. The verbal and all the words immediately related to it make up a verbal phrase. Like participles, participial phrases always serve as adjectives, modifying nouns or pronouns. Gerund phrases, like gerunds, always serve as nouns. Infinitive phrases may serve as nouns, adjectives, or adverbs. Because participle phrase could have same form as gerund phrases, the phrase link information file may have more than one meaning and/or function depending on the how they are used in sentences. The links for verbal phrases can also be established by using existing process files.

Absolute phrases consist of a noun or pronoun and a participle, plus any modifiers. Special use or meaning of the absolute phrases should be indicated in the link information file.

If the element is a symbol, a graphic, a sound or some other type of record, the second identification value 2112 through the ninth identification value 2119 could be any feature indication or a blank value. The element files may contain the link between each other, the link between it and a word or phrase, and other information related.

For a symbol, it may help to identify sentence structures, meaning and function of words and phrases, these information may be indicated by identification values and link information files.

The element files generally have words or word phrases as file names, thus processing conducted by executing system that involve searching the element files will be accomplished by searching the element files that have the words or word phrases as file names.

### Image Database Structure

As shown in FIG. 6, an image database structure can comprise an image identification zone, an image file address zone, an image feature zone for image characteristics values, more than one categorized zones for language units related in meaning with the images, and an image database organizing mechanism, wherein each image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones. Image characteristics can include information for the time the images are created, the picture resolution, whether the images are in public domain or whether it is protected by copyright etc.

In one preferred embodiment of the present invention, the language units associated with the images can be divided into these categories:
1. Comment—general impression or evaluation of the image
2. Main feature, general description
3. Main feature, detailed description
4. Background, general description
5. Background, detailed description
6. Style (artistic, commercial, portrait, landscape, etc.), color scheme (black and white, bright, subtle, etc.) of the image
7. Time (season), place, author, activities
8. Related things, things descriptively related to the image
9. Related things, things creatively related to the image

The searches in the image database structure can be done by searching the categorized zones for language units that can match with the inputted language units. Once matches are found, the corresponding images can be identified and accessed. The search results of images can be processed according to the inputted language units wherein if the matching language units are in certain categorized zones, for example categorized zone 2, then the corresponding images can be ranked higher than other search results. Image characteristics can also determine the ranking of the images. For example, the newest image can be ranked higher, and high resolution image can be ranked higher, and images that are in public domain can rank higher (or copyrighted images can ranked higher) depending on the goal of the ranking.

In one preferred embodiment of the present invention, if no direct match can be found in the image database structure, the inputted language units can be processed in the knowledge structure database to find language units that are similar in meaning, broader or narrower in meaning, or at least related in meaning with the inputted language units. Then the language units from the knowledge structure database can be used to search the image database structure to find matches.

In one preferred embodiment of the present invention, images can be matched and linked to contents with texts. In one preferred embodiment of the present invention, the texts in the web pages can be scanned and language units that match with language units in the categorized zones of the image database structure can be identified. Then, for each language unit, image search results can be arranged and displayed in a webpage and linked to the corresponding language unit. The webpage with images can also include links to web pages that provide related information and/or advertisement. The benefit of this feature is to enhance user experience and provide related information or promotions.

In another preferred embodiment of the present invention, image searches can be conducted using other language units in the contents along with the particular language unit. For example, language units in the content that can clarify or define the meaning of the language units for the searches can be used along with the main language units for searches, and if image database structure can provide matches to the main language units and the terms that could define or clarify the meanings of the main language units, then these matches could be ranked higher.

In one preferred embodiment of the present invention, as seen in FIG. 6, the language units that are related to images can be divided into different categories and assigned different values for each terms related to particular images. When conducting searches in image search database, the search results can be ranked according to the matched terms' categorization and values as well. For example, for detail description of the main feature of an image, certain descriptions can be more valuable, so they can be given higher values, and matches with descriptions with higher values can be ranked higher in the image search results.

### Executing System

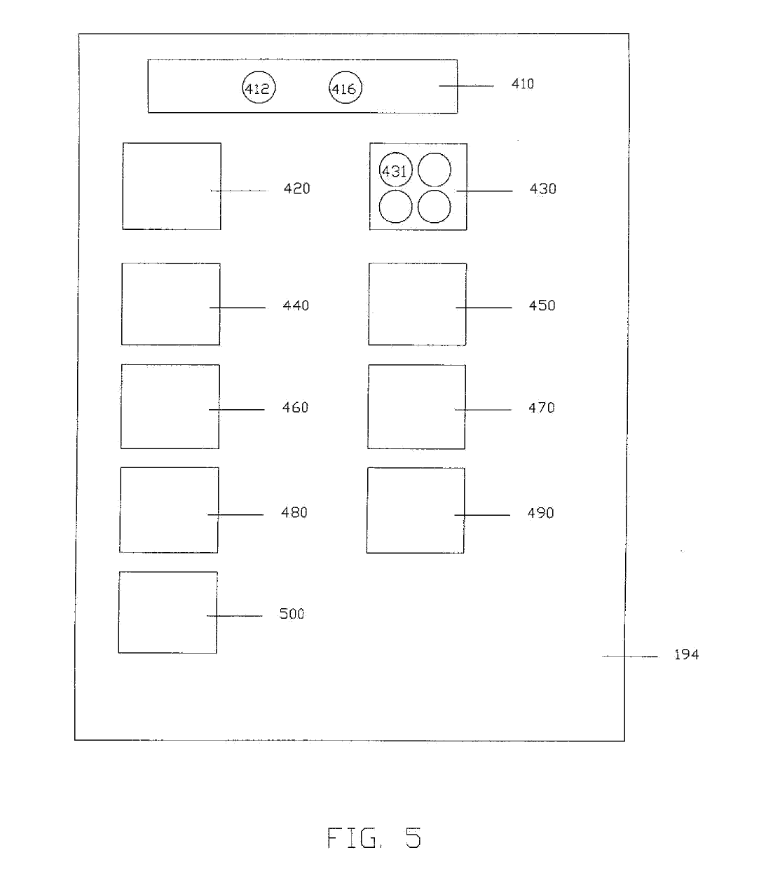

As seen in FIG. 5, the executing system 194 comprises an internal control mechanism 410, an inputting mode 420, a reading mode 430, at least one thinking mode 440, a writing mode 450 and a memorizing mode 460, an outputting mode 470, an inquiry mode 480, a verification mode 490, and a system update mode 500. The internal control mechanism 410 includes internal control rules 412 and structure rules 416. The inputting mode 420 includes inputting rules, wherein the reading mode 430 includes reading rules, wherein the thinking modes 440 include thinking rules, wherein the writing mode 450 includes writing rules, wherein the memorizing mode 460 includes memorizing rules, wherein the outputting mode 470 includes outputting rules, wherein the inquiry mode 480 includes inquiring rules, wherein the verification mode 490 includes verification rules, wherein the system update mode 500 includes system update rules. The internal control mechanism 410 can control the inputting mode 420, a reading mode 430, a thinking mode 440, a writing mode 450 and a memorizing mode 460, an outputting mode 470, an inquiry mode 480, a verification mode 490, and a system update mode 500, wherein the internal control mechanism 410 can operate constantly.

The internal control mechanism 410 includes internal control rules 412, wherein the internal control rules comprising basic rules, task rules, target rules, etc. Essentially, the internal control mechanism 410 is a decision making mechanism that decide and control the operating process of the thinking system. The internal control rules in combination with the rules for each mode allow the processes of present invention to be realized. The detailed embodiment of the internal control mechanism can vary, and the internal control rules will be different for various embodiments.

The internal control mechanism shall be able to control and direct operating process of the system of the present invention in all situations. The basic idea is to provide internal operation sequence for any and all kinds of situations. The basic sequence of operation of present invention is a sequence wherein the operation process of the thinking system in any and every situation will be decided. In the preferred embodiment of the present invention, the executing system preset the type of operation sequence for receiving inputs and information processes.

The basic rules of the internal control rules of the internal control mechanism 410 set up the basic operating process, wherein the basic rules control the basic operation such as when and how to switch from one mode to another, and setup the environment for each mode of operation. For example, a basic rule can be set that certain input will be given priority to other operations, that whenever this type of input is detected by the inputting devices, the executing system will switch to input mode, and suspend or abandon the on going process depending on the type of operation and designated by the basic rules. The basic rules can also set the default operating processes for the executing system.

The task rules of the internal control rules of the internal control mechanism 410 set up rules particular related to various tasks. For example, task rules for search tasks may provide particular ways of analyzing the input information and obtaining results to be used to conduct searches in the image database structure.

The target rules of the internal control rules of the internal control mechanism 410 set up the long term targets (tasks to be completed or worked on over a long period of times) or the underline targets (on going tasks that usually have low priorities than other types of task) of the system. When no other actions will be taken by the executing system, the executing system can operate according to the target rules.

In one preferred embodiment of the present invention, one target rule of the thinking system can be set to scan websites on the internet to obtain language units that can match with the language units in the image database structure, and conduct searches in the image database structure to find images that can be related in meaning to the language units, and rank the search results, write the search results to compose web pages and link the web pages to the language units in the websites.

In general, the internal control rules are files that contain commands that will be triggered by corresponding conditions. In any given time, and in any given point of the process of the executing system the thinking system is in certain condition, and the information that relates to the condition will often trigger internal control rules to direct the executing system to conduct the subsequent processes. The internal control rules can be in various formats, and what is essential is that inputs or internal conditions of the thinking system should be able to direct the executing system to process accordingly as directed by the internal control rules. Basically, the basic rules set up the basic framework of the process of the executing system, wherein the basic rules will direct the executing system to operate in various mode according to the current inputs or system conditions, and call upon various rules such as task rules, target rules, etc. to determine what processes should be conducted.

The inputting rules, the reading rules, the thinking rules, the writing rules, the memorizing rules, the outputting rules, the inquiring rules, the verification rules, and the system update rules all comprise rules that will direct the corresponding processes of the inputting mode, the reading mode, the thinking mode, the writing mode, the memorizing mode, the outputting mode, the inquiring mode, the verification mode, and the system update mode. Similar to the internal control rules, they are files that contain commands that will be triggered by corresponding conditions.

For example, the inputting rules may comprise rules that identify the types of inputs and send the information to the executing system so that the executing system can respond to the type of inputs according to the basic rules.

If the internal control mechanism 410 detects input information from the inputting devices of the information gathering system, the inputting mode 420 will be activated according to the internal control rules. According to the inputting rules, the inputting mode 420 takes input information from inputting devices of the information gathering system, such as key board, microphone, internet site, and other inputting devices and converts the input information into format that can be read by the executing system 194.

The reading mode 430 processes information received from inputting devices and converted by inputting mode 420. Preferably, the reading mode 430 comprises word processing 431, and other information processing. For word processing 431, one default language can be set, and can be overwritten by inputting information. For word processing 431, the information preferably will be divided into sentences by specified sentence dividing mark, or symbolized either by combination of period (or question mark, exclamation point, etc.), space and capital letter, or by other symbols. In reading the sentences, each word (or other language unit) in the sentences can be identified by searching and locating the corresponding element file of each word (or other language unit) in the knowledge structure according to the file organizing mechanism, then the element files can be loaded to a temporary location easily accessible by the executing system 194.

When thinking mode 440 is put into action by internal control mechanism 410 according to the internal control rules, not triggered by input information, the thinking mode 440 can make new direct links between existing elements according to the information in the existing element files, or make new link process files according to the existing link process files and information in the existing element files. According to the internal control rules, the internal control mechanism 410 can also try to make assumptions such as providing hypothetical tasks imitating the real life tasks and try to complete the tasks so that to obtain new direct links and new link process files.

In a preferred embodiment of the present invention, if the thinking mode 450 established links between the existing elements, once the success links are established, the routes for making the link are identified and saved by the memorizing mode 460. This information can be saved in a preferred process file of the process file structure, wherein the element files of the given words and critical words, and important link words will contain information referring to this process file. The process file can be identified by the given words, critical words, and/or important link words.

The preferred process file can be generalized and expended to provide more link route by thinking mode 440. When the process file structure is established, the problem solving process may start with search the process file structure for process file that matches the given words and critical words of the problem. This will save time and effort.

In a preferred embodiment, the entire process of the executing system may be document and identified by contents and time of execution by memorizing mode 460 as a system log file, and can be used for verification, generalization, and expansion of the process file, and any other purposes.

The outputting mode of the internal control mechanism controls output devices to write word and/or image display output to display devices, or to other output devices.

The inquiry mode 480 can inquire information either from the image database structure, outside sources, or human operators. Technically, the image database structure does not need to be part of the thinking system, but the operation of the image database structure must be compatible with the thinking system, if thinking system is used in the process.

When the inquiry rules lead to the image database structure to search for the images, the process is basically a search process, therefore the inquiry rules will include searching rules.

In one preferred embodiment of the present invention, the searches in the image database structure are done by searching the categorized zones for language units, wherein the inputted language unit can first be processed by the executing system and the executing system can look up the knowledge structure and find matching element file, wherein language units related to the input language unit in the knowledge information files can be used to search the image database structure independently or along with the inputted language unit.

For example, if the inputted language unit is a word “flower”, then the executing system can access the element file of “flower”, and retrieve language units related to the word “flower” in the knowledge information files of “flower”. The first link information file of the element file of “flower” could include words or phrases such as plant (broader in meaning), pensy (narrower in meaning), rose (narrower in meaning), water lily (narrower in meaning), etc. The second link information file of the element file of “flower” could include words or phrases such as “flowers”, “fleur”, that are similar in meaning to “flower”. All these words can be used to search image database structure independently. The third link information file of the element file of “flower” could include information such as “A flower has color”, thus word “color” can be used to search the image database along with the word “flower”, the same type of language units obtained from other link information files could be used to search the image database along with the word “flower”.

In searching the image database, the executing system can try to find if there is a match in any of the categorized zone. If a match is found, the corresponding image address can be used to retrieve the corresponding image. If one language unit is used to do the search, then images with categorized zones including the same language unit will be selected and the result can be displayed according to in which categorized zones the matches are found.

For example, if the language unit is a word “flower”, then if matches are found at the categorized zone for main feature, then the corresponding image will rank high. The image search results can also be ranked according to the comment zone. For example, if the comment zone has comments such as “the most beautiful picture”, then the image would rank higher among images that otherwise have similar rankings. Images with what categorized features should be ranked higher are to be determined by the ranking rules. Ranking rules are to be established in the executing system and the executing system can rank image search results according to the ranking rules.

In a preferred embodiment, the new link information obtained from generalizations or inductions by thinking mode 440 memorizing mode 460 can be verified by verification mode 490, and to be used to update the related element files.

In a preferred embodiment, the operating process of the executing system 194 can be saved according to operating time of the executing system 194 and related element files and link process files to system log files in the system log. The system log files can be used for many purposes. They will be especially useful when certain direct links in certain element files need to be revised, for the system log files can provide the records of changes to other element files or link process files in the past based on those direct link information and revise other element files or link process files.

In one preferred embodiment of the present invention, articles (web articles or other text based documents in computer systems) can be processed by the executing system of the present invention. In one preferred embodiment of the present invention, the articles can be processed to obtain language units that can be linked to images. In one preferred embodiment of the present invention, the language units in the categorized zones of the image database structure are all listed in a language unit database, wherein all the language units are arranged in an order that can be easily accessible by the executing system. The language unit database can be used by the executing system to craw the article to find matches between the language units in the language unit database with language units in the article. All the matches from the article can establish a list and saved in a file by the executing system. In one preferred embodiment of the present invention, the executing system can conduct a search for each language unit in the article that can find matches in the language unit database in the image database structure, and the search results can be ranked according to ranking rules as stated above.

In another preferred embodiment of the present invention, the executing system can conduct a search for each language unit along with other language units in the article. For example, along with each of the language unit in the article that is selected to search the image database structure, other language units in the article can also be used to find relevance of the images. For example, if the language unit in the article that is selected to search the image database structure is the word “flower”, then other language units in the article such as word “nature”, “outdoor”, etc. can also be used along with the word “flower” to search the images. Thus, if an image who's categorized zones include word “flower” and “nature” and/or “outdoor”, then this image will be included in the search results and ranked high. In another preferred embodiment of the present invention, the executing system can first retrieve information from the element file of the language unit in the article that is used for the search, and the information from the element file will be expressed in language units as well. These language unites are matched with the list of language units in the article and the resulted matches will be used to search image database structure along with the chosen language unit for the search.

In another preferred embodiment of the present invention, if articles are summarized to obtain key language units, the key language units and language units obtained from the element files of the key language units can be used along with the chosen language unit for the search, to obtain more relevant images.

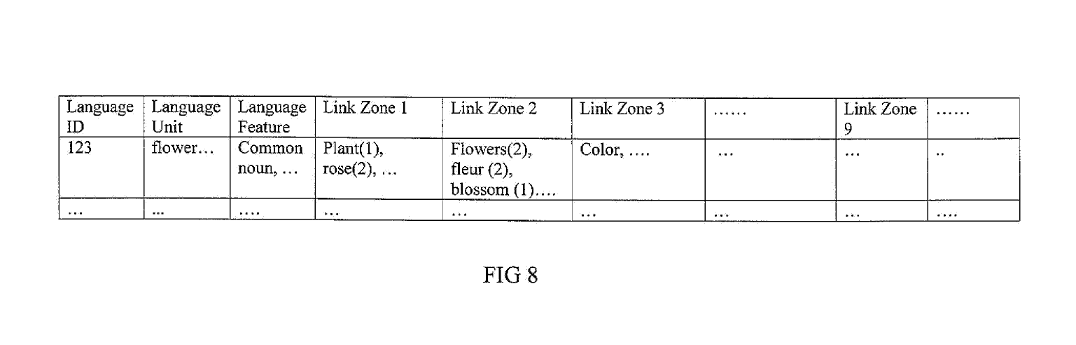

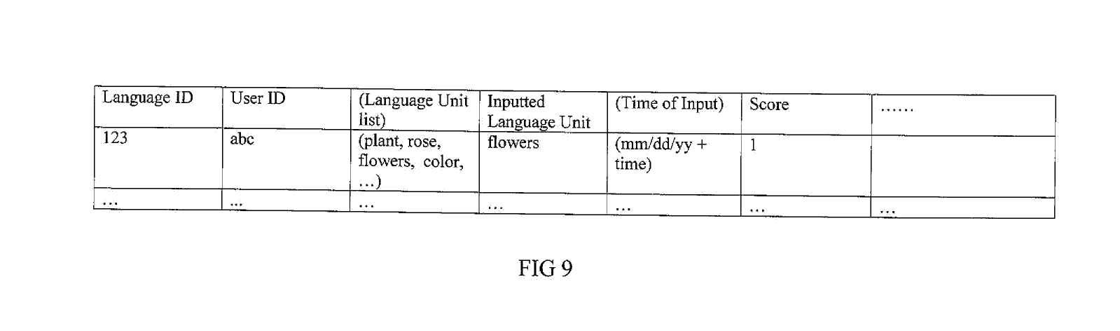

In one alternative embodiment of the present invention, as shown in FIG. 8, a language association database for language to language association can be established. In a preferred embodiment, as shown in FIG. 9, a user input language database can be established first. A list of language units can first be established, and the executing system can randomly display language unit one by one, and participants can respond to displayed language units by inputting language units related in meaning to the displayed language units. The inputs from the participants can be categorized according to divisions in element files. In one preferred embodiment of the present invention, the inputs from the participants can be evaluated according to the types of connections between inputted language units and the displayed language units, wherein different scores can be given to the participants according to the types of connection. For example, if the language unit is “flower”, then “plant”, “pensy”, “rose”, “flowers”, “fleur”, “color” are all language units related in meaning to the language unit “flower”, and evaluation of the input can be done according to whether these language units are to be in the first, second, or third link information files, etc., and scores can be given for these input. The structure and operation of these databases are similar to image database structure and user input image database. The language association database can be use directly for processes that require to use language units that are related in meaning to other language units. For example, in conducting image search in image database structure, if no direct match can be found in the input language unit or otherwise language unit used for the search, then language units in the language association database can be used for the search, and language units in different link zones can be given priorities than others (and language units with different values can be given different priorities). For example, language units in link zone 2 can be given priorities than link zone 1, and language units in other link zones should be used along with the language units in link zone 2 and link zone 1 for searches, but not used independently for searches.

What is claimed is:

1. A method for operating a human-made system including one or more CPU's, one or more I/O devices, and one or more memories, comprising the steps of:
establishing a knowledge structure including a language file organizing mechanism, and more than one language element files, wherein the language element files include identifying information and knowledge information;
establishing an image database structure; and establishing an executing system.

2. A method as claimed in claim 1, wherein the image database structure further comprises an image identification zone, an image file address zone, an image feature zone for image characteristics values, more than one categorized zones for language units related in meaning with the images, and an image database organizing mechanism.

3. A method as claimed in claim 2, wherein each of image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones.

4. A method as claimed in claim 3, wherein the image characteristics values include information for the time the images are created, the picture resolution.

5. A method as claimed in claim 4, wherein the executing system display images to users, receiving corresponding inputs from users, and comparing the inputs with corresponding language units in categorized zones of the image database structure, and providing corresponding scores to users.

6. A human-made system including one or more CPU's, one or more I/O devices, and one or more memories, comprising a knowledge structure, including a language file organizing mechanism, and more than one language element files, wherein the language element files include identifying information and knowledge information; and an image database structure.

7. A system as claimed in claim 6, wherein the image database structure further comprises an image identification zone, an image file address zone, an image feature zone for image characteristics values, more than one categorized zones for language units related in meaning with the images, and an image database organizing mechanism.

8. A system as claimed in claim 7, wherein each of image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones.

9. A system as claimed in claim 8, wherein the image characteristics values include information for the time the images are created, the picture resolution.

10. An image database structure system including one or more CPU's, one or more I/O devices, and one or more memories comprising: an image identification zone, an image file address zone, an image feature zone for image characteristics values, more than one categorized zones for language units related in meaning with the images, and an image database organizing mechanism.

11. A system as claimed in claim 10, wherein each of image identification value corresponds to a particular image with an image file address, and more than one categorized zones for language units related to the corresponding images, wherein the image database organizing mechanism provides access to the images identifications, image addresses, image characteristics, and language units related in meaning to the images in more than one categorized zones.

12. A system as claimed in claim 11, wherein the image characteristics values include information for the time the images are created, the picture resolution.
